(19) United States
(12) Patent Application Publication
(10) Pub. No.: US 2016/0233490 A1
(43) Pub. Date: Aug. 11, 2016

(54) Silicon-Based Powder and Electrode Containing the Same

(71) Applicant: UMICORE, Brussels (BE)

(72) Inventors: Stijn PUT, Olmen (BE); Jean-Sebastien BRIDEL, Grenoble (FR); Nathalie DELPUECH, Oxfordshire (GB); Bernard LESTRIEZ, Nantes (FR); Philippe MOREAU, Saint Mars du Desert (FR); Nicolas DUPRE, Nantes (FR)

(21) Appl. No.: 14/903,066

(22) PCT Filed: Jul. 3, 2014
(86) PCT No.: PCT/EP2014/064190

§ 371 Date: Jan. 6, 2016

(30) Foreign Application Priority Data
Jul. 10, 2013 (EP) 13175913.6

(51) Int. Cl. H01M 4/36; H01M 4/134; H01M 4/48; H01M 4/131; H01M 4/62; H01M 4/38

(52) U.S. Cl. CPC H01M 4/366; H01M 4/622; H01M 4/386; H01M 4/483; H01M 4/131; H01M 4/134; H01M 2004/027

(57) ABSTRACT

The invention relates to a powder comprising particles containing a core and a shell, said powder preferably having a surface area (BET) of at most 50 m²/g, said core containing silicon (Si) and said shell containing silicon oxide SiOₓ with 0<x≦2, wherein said silicon oxide contains Siⁿ⁺ cations with n being an integer from 1 to 4, wherein said silicon oxide contains Si⁴⁺ cations in an amount of at least 70 mol % from the total amount of Siⁿ⁻ cations.

The invention relates to a powder, in particular a silicon-based powder and a method for manufacturing the same. The invention further relates to negative electrodes for Li-ion batteries comprising said powder and batteries comprising the same.

Lithium-ion batteries are the most widely used secondary systems for portable electronic devices. Compared to aqueous rechargeable cells, such as nickel-cadmium and nickel metal hydride, Li-ion batteries (or cells) have higher energy density, higher operating voltages, lower self discharge and low maintenance requirements. These properties have made Li-ion cells the highest performing available secondary battery.

In particular graphitic carbon is used as a material for manufacturing negative electrodes (“anodes”) for Li-ion cells. The graphitic carbon distinguishes by its stable cycle properties and its very high safety with regard to handling in comparison with other materials such as lithium metal, used in so-called “lithium batteries”. A disadvantage however of graphitic carbon lies in its electrochemical capacitance (theoretically 372 mAh/g), which is much lower than that lithium metal (theoretically 4235 mAh/g).

Providing new materials for the negative electrode of Li-ion cells has therefore been the subject of many investigations for more than a decade. As a result of such investigations, Si-based negative electrode materials were developed which could provide significantly enhanced energy densities. Silicon has a large theoretical gravimetric capacity (3579 mAh/g) corresponding to the following reaction: 15 Li+4 Si→Li₁₅Si₄ and a large volumetric capacity (2200 mAh/cm³) also. However, the microscopic structure of silicon based materials and their huge volume expansion upon lithium intercalation had not yet allowed reaching acceptable life characteristics for their use in Li-ion cells. To overcome some of the above mentioned drawback of silicon based materials, materials were synthesized at submicron (nano-) scale, which makes them suitable candidates for the replacement of graphitic carbon. A method to prepare submicron silicon-based powders is plasma technology, as is disclosed in WO 2008/064741 A1.

Many investigations were also carried out in an attempt to further prevent the volume expansion of Si-based materials such as the use of silicon oxide (SiOx) based materials where x can be anywhere above 0 and below 2. Although SiO₂ has a good stability when including Lithium ions, process also termed “lithiation”, other oxides where 0<x<2 may still show a noticeable volume expansion (see A. N. Dey, J. Electrochem. Soc., 118(10), 1547. (1971)).

Further advances in the negative electrode technology for Li-ion cells utilizing silicon and silicon-based materials can be found in U.S. Pat. No. 8,124,279 disclosing electrode materials comprising nanoscale silicon particles with a BET surface area of 5 to 700 m²/g; U.S. Pat. No. 8,420,039 disclosing a negative electrode for a lithium-ion battery, comprising a SiOₓ powder with 0.7<x<1.5; and WO 2012/000858 disclosing a Si based powder having an average primary particle size between 20 nm and 200 nm, wherein the powder has a surface layer comprising SiOx, with 0<x<2, the surface layer having an average thickness between 0.5 nm and 10 nm, and wherein the powder has a total oxygen content equal or less than 3 percent by weight at room temperature.

In a yet further attempt to improve such electrodes, Miyachi et al. (Abs. 311, 206th Meeting,© 2004 The Electrochemical Society, Inc.) deposited SiO films on Cu foil by vapor deposition. XPS spectra of the SiO films showed the presence of five different Si oxidation states, the most prominent being Si³⁺ and Si⁰. However, the properties of such electrodes can be further optimized.

EP 2343758 discloses core-shell SiOₓ-based powders having different values of x in the core and in the shell, with a generally low SiO₂ content in the shell, never exceeding a value of 41.4% SiO₂.

The work reported in the publications mentioned hereinabove constitutes attempts for improving the negative electrode of a secondary Li-ion battery.

However, in spite of their merits, further developments are necessary to realize the next step of improvement; in particular to provide Li-ion batteries having smaller irreversible capacity losses in the first cycle as well as a suitable cycle life.

It may thus be an object of the present invention to provide a silicon-based powder with optimized properties which in turn may advantageously influence the properties of a negative electrode for Li-ion batteries containing thereof, as well as those of said batteries comprising said electrode.

The invention provides a powder comprising particles containing a core and a shell, said powder preferably having a surface area (BET) of at most 50 m²/g, said core containing silicon (Si) and said shell containing silicon oxide SiOₓ with 0<x≦2, wherein said silicon oxide contains Siⁿ⁺ cations with n being an integer from 1 to 4, wherein said silicon oxide contains Si⁴⁺ cations in an amount of at least 70 mol % from the total amount of Siⁿ⁺ cations.

It should be noted that throughout this document, the word silicon is used to refer to zerovalent silicon. Other oxidation states of silicon are indicated directly or through the fact that Si atoms in such other oxidations states are chemically bonded to oxygen.

Surprisingly, it was found that the powder of the invention provides a Li-ion secondary battery with a smaller irreversible capacity loss when the negative electrode of said battery is manufactured from said powder. Moreover, it was observed that said electrode has a good mechanical resistance and maintains its integrity during cycling.

According to the invention, the SiOₓ layer contains Siⁿ⁺ cations with n being an integer from 1 to 4, wherein the Siⁿ⁺ cations are in an amount of at least 70 mol % from the total thereof. Preferably, the amount of Siⁿ⁺ cations is at least 75 mol %, more preferably at least 80 mol %. Preferably, the summed amount of Si^{m+} cations with m being an integer from 1 to 3, i.e. Si⁺+Si²⁺+Si³⁺, is at most 30 mol %, more preferably at most 25 mol %, most preferably at most 20 mol %.

Good results were obtained when the amounts' ratio according to Formula 1:

$$amount {Si}^{4 +} \text{/} {\sum }_{m = 1}^{3} amount {Si}^{m +} \qquad Formula 1$$

is at least 2, more preferably at least 3, most preferably at least 4. Preferably, the amount of Si⁴⁺ cations is at least 75 mol %, more preferably at least 80 mol %

Also good results were obtained when the amounts' ratio according to Formula 2:

amount Si⁴⁺/amount Si⁺ 2

is at least 5.0, more preferably at least 7.5, most preferably at least 10.0. Preferably, the amount of Si⁴⁺ cations is at least 75 mol %, more preferably at least 80 mol %.

According to the invention, the particles forming the inventive powder contain a core and a shell. The shell which contains the SiOₓ may completely or partially surround said core. Preferably, said shell completely surrounds said core. Preferably, the shell has a thickness of at least 0.5 nm, more preferably at least 0.75 nm, most preferably at least 1.0 nm. Preferably, in order to maintain a good ionic and electrical conductivity of the inventive powder, said shell has a thickness of at most 10.0 nm, more preferably at most 7.5 nm, most preferably at most 5.0 nm.

In a preferred embodiment, the inventive powder comprises particles containing a core and a shell, wherein the core comprises silicon, wherein the shell has a shell outer-surface and a shell volume, wherein the shell volume comprises SiOₓ with 0<x<2 and the shell outer-surface comprises SiO₂.

In a further preferred embodiment, said core has a core-surface and said shell has a shell volume and a shell outer-surface, wherein the shell volume comprises SiOₓ wherein x has a continuous rate of change with respect to the thickness of the shell, from 2 at the shell outer-surface to 0 at the core-surface. It was observed that when x shows such a gradient, the stability of the inventive powder may be improved. In particular it was surprisingly observed that the inventive powder may show a decreased reactivity to humidity or water; which in turn imparts to said powder longer storage life. The decreased reactivity to water is also particularly advantageous during electrode preparation where the production of gases, e.g. hydrogen, needs to be reduced or even eliminated. The inventive powder may enable thus an optimal preparation process for negative electrodes with a homogeneous structure and optimal properties. The invention therefore further relates to a powder comprising particles containing a core and a shell, said core containing silicon (Si) and said shell having a shell volume and a shell outer-surface and containing silicon oxide SiOₓ with 0<x≦2, wherein x has a continuous rate of change with respect to the thickness of the shell, from 2 at the shell outer-surface to 0 at the core-surface.

In a preferred embodiment, the shell has an outer-surface, wherein said outer-surface comprises SiOH-free groups, i.e. individual SiOH groups having one OH group per Si. Preferably, the amount of SiOH groups is between 0.5 and 1.5 groups per nm², more preferably between 0.8 and 1.3 groups per nm², most preferably between 1.0 and 1.2 groups per nm². One method of providing such groups on said shell's outer-surface in the desired amounts is disclosed in example 4 of PCT/EP2012/075409, included herein in its entirety by reference. It was observed that during the preparation of a negative electrode composition where a binder, e.g. carboxymethyl cellulose (CMC), is used also to provide handleability to said composition, the presence of SiOH groups facilitates the good interaction between the inventive powder and the binder while providing an acceptable level of electrolyte degradation.

In a further preferred embodiment, the shell has an outer-surface, wherein said outer-surface comprises SiOH groups, preferably in the amounts indicated immediately hereinabove, and wherein said shell further comprises O_{z}SiH_{y} groups with 1<y<3 and z=4−y. Preferably the O_{z}SiH_{y} groups are OSiH3 groups. The skilled person can create such groups on said shell's outer surface by following the methodology disclosed in example 4 of PCT/EP2012/075409, included herein in its entirety by reference. The inventive powder preferably has a total oxygen content at room temperature of at least 3.0 wt % calculated based on the total amount of the powder, more preferably of at least 4.0 wt %. In a preferred embodiment, said total amount of oxygen is between 3.0 and 30.0 wt %, more preferably between 4.0 and 20.0 wt %, most preferably between 4.2 and 12.0 wt %. The skilled person may vary the amount of oxygen contained by the inventive powder by using for example the technique disclosed in WO 2011/035876 included in its entirety herein by reference.

The inventive powder preferably has a negative zeta potential in a pH interval between 3.0 and 9.5. Preferably said zeta potential is positive in a pH interval of less than 3.0. A method to adjust the zeta potential of a powder is disclosed for example in PCT/EP2012/075409.

Preferably, the inventive powder has an average primary particle size of between 0.01 μm and 1 μm, more preferably of between 20 nm and 200 nm, wherein said average primary particle size (day) is calculated from a specific surface area, assuming spherical particles of equal size, according to the following Formula 3:

$${d}_{av} = \frac{6}{ρ \times BET} \qquad Formula 3$$

in which ρ refers to a theoretical density of the powder (2,33 g/cm³) and BET refers to the specific surface area (m²/g).

Preferably, the BET of the inventive powder is at most 30 m²/g, more preferably at most 25 m²/g, most preferably at most 20 m²/g. Preferably, said BET is at least 5 m²/g, more preferably at least 10 m²/g, most preferably at least 15 m²/g.

The inventive powder may further comprise an element M selected from the group consisting of transition metals, metalloids, Group IIIa elements and carbon. In one embodiment M comprises either one of more elements of the group consisting of nickel, copper, iron, tin, aluminum and cobalt. Most preferably M is Al or Fe.

The invention further relates to a method for manufacturing the inventive powder, comprising the steps of:
a. Providing a powder comprising particles, said particles comprising a core containing silicon and an initial shell having a shell outer-surface and a shell volume, wherein the shell volume comprises SiOₓ with 0<x≦2 and wherein said shell has a shell thickness of between 0.5 nm and 3 nm and a BET of between 10 and 40 m²/g;
b. Subjecting the powder to an etching step with a HF water-based solution to partially remove and/or reduce the thickness of the SiOₓ shell and produce SiOH groups on the outer-surface of the shell; and
c. Subjecting the etched powder to an oxidizing heat treatment at an oxidizing temperature of between 250° C. and 750° C. for between 5 min and 80 min to obtain a powder having a BET of at most 50 m²/g and containing particles comprising a core containing silicon and a shell comprising a silicon oxide SiOₓ with 0<x≦2, wherein said silicon oxide contains Siⁿ⁺ cations with n being an integer from 1 to 4, wherein said silicon oxide contains Si⁴⁺ cations in an amount of at least 70 mol % from the total amount of Siⁿ⁺ cations.

The powders used in the process of the invention, are commercially available powders, from e.g. Sigma Aldrich; Alfa Aesar. Preferably, the utilized powder is a powder produced in accordance with example 1 of WO 2012/, included herein in their entirety by reference.

Preferably, the HF water-based solution has a concentration of at least 1.0%, more preferably at least 1.5%, most preferably at least 2.0%. Said HF solution, preferably has a concentration of at most 5.0%, more preferably at most 4.0%, most preferably at most 3.0%.

Preferably, the powder is subjected to etching by adding said powder to said HF and keep the powder in said solution for at least 5 minutes, more preferably, most preferably for at least 10 minutes. Preferably, stirring is used while etching. Preferably etching is carried out at room temperature.

According to the invention, the etching step partially removes and/or reduces the thickness of the shell and produce SiOH groups and O_{z}SiH_{y} groups with 1<y<3 and z=4−y, on its outer-surface. Preferably, the etching step is carried out in a time interval adjusted to produce an amount of SiOH groups of between 0.8 and 1.4 groups per nm², most preferably of between 1.0 and 1.2 groups per nm².

The etched powder is then subjected to an oxidizing heat treatment at a carefully chosen oxidizing temperature of between 250° C. and 750° C. for a carefully adjusting oxidizing time of between 5 min and 80 min. The oxidation is preferably carried out in air. It was observed that the combination of the oxidizing temperature and the oxidizing time is important for obtaining powders with good properties.

Before oxidizing, however, the etched powder can be subjected to a filtering and/or washing step, preferably followed by drying. The washing is preferably carried out in a solvent volatile at a temperature close to room temperature, more preferably room temperature. Ethanol is a suitable example of such a preferred solvent.

In a preferred embodiment, the oxidizing temperature is between 200 and 400° C. and the oxidizing time is between 5 and 20 minutes. Preferably, said oxidizing temperature is between 250 and 350° C. and said oxidizing time is between 8 and 15 minutes. More preferably, said oxidizing temperature is between 290 and 310° C. and said oxidizing time is between 10 and 12 minutes.

In another preferred embodiment, the oxidizing temperature is between 600 and 800° C. and the oxidizing time is between 5 and 80 minutes. Preferably, said oxidizing temperature is between 650 and 750° C. and said oxidizing time is between 8 and 40 minutes. More preferably, said oxidizing temperature is between 690 and 810° C. and said oxidizing time is between 10 and 30 minutes.

In a more preferred embodiment, the oxidizing temperature is between 200 and 400° C. and the oxidizing time is between 25 and 80 minutes. Preferably, said oxidizing temperature is between 250 and 350° C. and said oxidizing time is between 30 and 70 minutes. More preferably, said oxidizing temperature is between 290 and 310° C. and said oxidizing time is between 30 and 60 minutes.

In the most preferred embodiment, the oxidizing temperature is between 410 and 590° C. and the oxidizing time is between 8 and 80 minutes. Preferably, said oxidizing temperature is between 450 and 550° C. and said oxidizing time is between 20 and 60 minutes. More preferably, said oxidizing temperature is between 490 and 510° C. and said oxidizing time is between 30 and 40 minutes.

The powder obtained according to the method of the invention is utilized into a composition used to manufacture a negative electrode for a Li-ion cell. Preferably said composition contains between 70 wt % and 90 wt % of the inventive powder, between 5 wt % and 15 wt % of a conductive agent, e.g. carbon, and between 5 wt % and 15 wt % of the binder with the sum of the constituents being 100 wt %.

Preferably, said electrode composition has a 1^{st} irreversible loss of at most 560 mAh/g, more preferably of at most 450 mAh/g, even more preferably of at most 400 mAh/g, most preferably of at most 360 mAh/g when prepared and tested as instructed in sections “ELECTRODE PREPARATION” and “ELECTROCHEMICAL TESTING” hereinbelow.

Preferably, the cycle life of said electrode composition is at least 300 cycles, more preferably at least 400 cycles, most preferably at least 500 cycles.

The invention further relates to an electrode suitable for use as a negative electrode for a Li-ion cell, said negative electrode comprising the inventive powder as active material. It was observed that the inventive electrode may show a decreased Li consumption and good performance on long term cycling.

The invention further relates to a Li-ion cell comprising the inventive electrode and to battery packs comprising said cell. The invention further relates to various electronic and electrical devices comprising the inventive Li-ion cell.

The invention will be further explained with the help of the following figures, examples and comparative experiments, without being however limited thereto.

Hereinafter the Figures are explained:

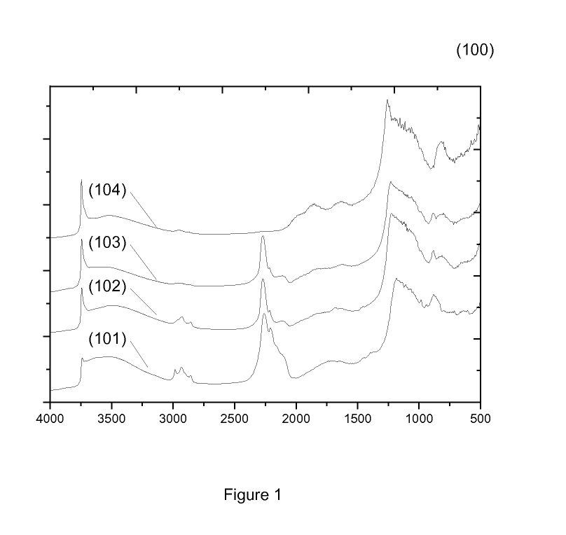

FIG. 1 shows a chemical composition of the surface of particles forming the inventive powder as determined by DRIFT Spectroscopy. The graph represents the intensity of the IR absorbance signal in arbitrary units (a.u.) versus the wavenumber (cm⁻¹).

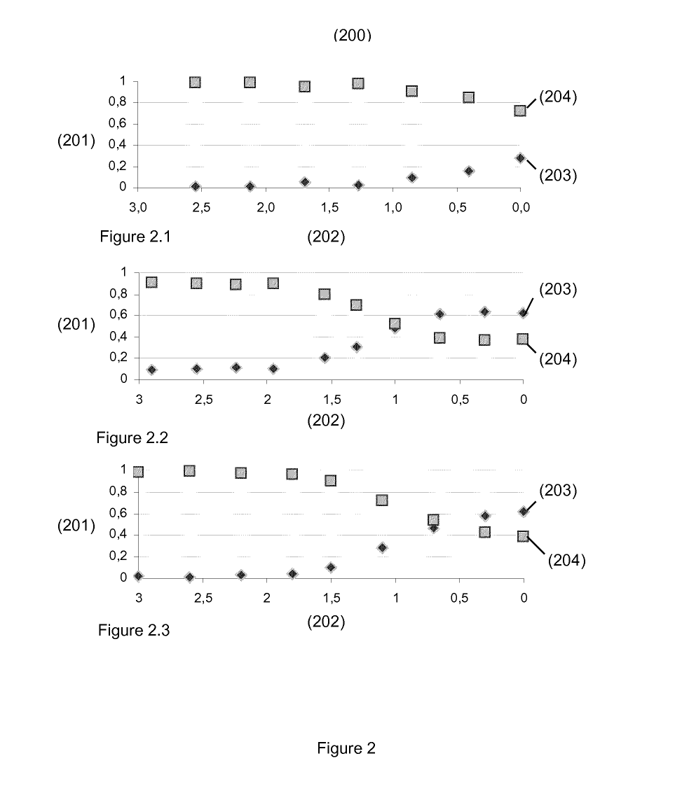

FIG. 2 shows a comparison of the variation of the Oxygen content throughout the thickness of the particles' shell between the inventive particles and state of the art particles.

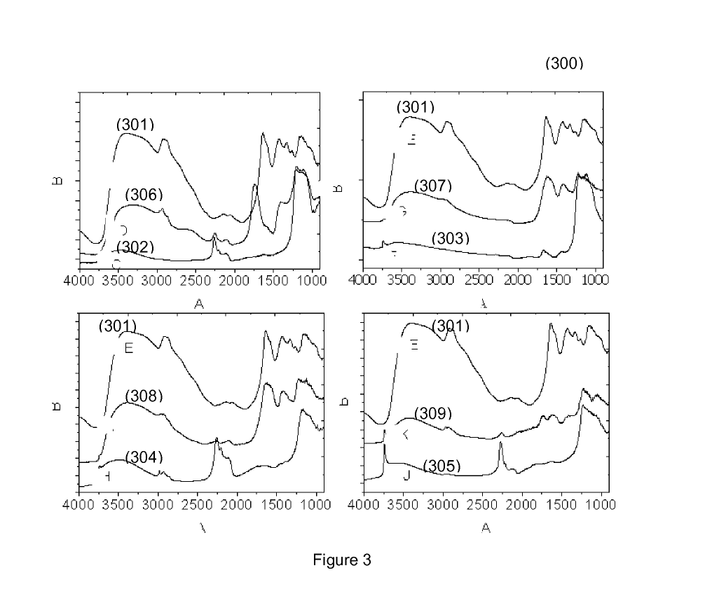

FIG. 3 shows the chemical composition determined by DRIFT of negative electrodes of the invention.

### METHODS FOR MEASUREMENT

The zeta potential is determined in demineralized water at various values of pH with a zetasizer nanoseries (Malvern Instrument). The pH was adjusted with HCl 0.25M. Smoluchowski's theory is used for calculations.
BET of a powder is determined by nitrogen adsorption method of Brunauer-Emmett-Teller (BET technique) at 77 K using an ASAP 2000 instrument from Micrometrics.
The amount of Siⁿ⁺ cations is determined by XPS analysis and deconvolution of signals following the methodology described in Chapter 2 (Study of SiO2/Si Interface by Surface Techniques by C. Logofatu et al.) of Crystalline Silicon—Properties and Uses, edited by Prof. Sukumar Basu, ISBN 978-953-307-587-7; available from: http://www.intechopen.com/books/crystalline-silicon-properties-and-uses/study-of-sio2-si-interface-by-surface-techniques. The oxygen content of a SiOx containing material is determined as follows: the total oxygen content of powders is determined with the Leco TC600 oxygen-nitrogen analyzer. The sample is first put in a closed tin capsule. The tin capsule is then put in a graphite crucible and heated under helium as carrier gas till very high temperatures. In this heating process, the whole feed is melted and oxygen is then set free from its bonding to Si and reacts with the graphite from the crucible, forming CO or CO₂ gas. These gases are guided into an infrared measuring cell. The observed signal is converted to an oxygen content.
The thickness of the SiOₓ containing shell of a particle can be determined by a scanning transmission electron microscope (STEM) and electron energy loss spectroscopy (EELS) measurements using a FEI Titan 50-80 commercial device with an acceleration voltage of 80 V.
The chemical composition of the surface of a particle, i.e. the outer-surface of the particle's shell, was investigated by infrared spectroscopy (using the Diffuse Reflectance collection mode with a vertex 70 Bruker spectrometer, in the medium and near infrared ranges). DRIFT Infra-red spectrometry reveals the presence of various crystal modes as well as a Si-O-Si mode at around 1100 cm⁻¹. The peaks around 3500 cm⁻¹ are attributed to hydroxylated silanol group. Between 2260 and 2110 cm⁻¹, different peaks can be assigned to OySiHx deformation modes.
The gradient in Oxygen content throughout the thickness of the SiOₓ containing particle's shell was measured by scanning transmission electron microscope (STEM) and electron energy loss spectroscopy (EELS) measurements using a FEI Titan 50-80 commercial device with an acceleration voltage of 80 V.

### COMPARATIVE EXPERIMENT 1

A commercial crystallized Silicon nano-powder from Alfa Aesar was analyzed. The properties reported in the table under C-Ex 1 in the section ‘powder characterisation’ were obtained.

The powder had a BET of 57 m²/g, an oxygen content of 6 wt % and an initial negative zeta potential (defined at pH6 in water). The zeta potential became positive at pH 3. The particles had an approximately 2 nm thick shell comprising SiOₓ with 0<x<2 and contained free and bonded silanols groups and OySiHx. The amount of free SiOH groups was about 1.2±0.2 groups/nm².

### COMPARATIVE EXPERIMENT 2

0.5 g of a silicon nano-powder was produced using the methodology described in Example 1 of WO 2012/000858 with adapted processing parameters.

The powder was analyzed, and the properties reported in the table under C-Ex 2 in the section ‘powder characterization’ were obtained.

### EXAMPLE 1

The powder from comparative experiment 2 was stirred in a 2% HF solution with magnetic stirring for 10 minutes. Subsequently, the powder was washed with ethanol to remove HF and dried at room temperature. This dried powder was oxidized at 300° C. in air during 10 minutes in a tubular furnace, as indicated in the table under Ex 1 in the section ‘powder manufacturing conditions’.

The characteristics of the obtained powder are given in the table under Ex 1 in the section ‘powder characterization’. The powder had an initial negative zeta potential. The zeta potential became positive at a pH lower than 2.2.

In FIG. 1 showing the chemical surface composition (100) given by the IR signal represented in arbitrary units (a.u.) versus the wavenumber (in cm⁻¹) of particles forming the various powders produced in accordance to the invention, peaks between 1200 cm⁻¹ and 1100 cm⁻¹ corresponding to Si-O-Si groups can be observed. The corresponding spectrum for the powder of this example is indicated as (101). The peaks between 2300 cm⁻¹ to 2100 cm⁻¹ can be assigned to the stretching band of OySiHx groups (with 0<y<3 and x=4−y). The emerging peak at around 3740 cm⁻¹ is characteristic for a free SiOH group (or isolated silanols). The broad absorption region between 3730 cm⁻¹ and 3400 cm⁻¹ can be assigned to bonded SiOH groups (corresponding to molecular absorbed water or interaction of the oxygen of the OH groups with the hydrogen of a neighboring OH). The peak between 4600 cm⁻¹ and 4300 cm⁻¹ is characteristic of all SiOH groups (bonded and free).

The amount of free SiOH groups as determined by using ATG and infrared spectroscopy was about 0.9±0.2 groups/nm².

### EXAMPLES 2-9

Example 1 was repeated except that the powder was oxidized at 300; 500 and 700° C. for between 10 and 60 minutes. The manufacturing conditions and characteristics of the powders are shown in Table under Ex 2 to Ex 9. The chemical composition of the powders of Examples 4, 5 and 9 was determined and the respective IR curves were indicated as (102), (103) and (104) in FIG. 1, respectively.

The variation (200) of the Oxygen content in % (201) in the silicon oxide SiOₓ, i.e. the variation of x, with the thickness (202) of particles' shell (in nm) is evidenced in FIG. 2 for the powders of Comparative Experiment 2 (FIG. 2.1); Comparative Experiment 1 (FIG. 2.2) and of Example 5 (FIG. 2.3). The outer-surface of the shell corresponds to 0 nm. For the particles forming the powder of Example 5, the outer-surface of their shell contains SiO₂ (60% O₂ and 40% Si) with a content (203) of the O₂ (indicated by ♦) that is gradually decreasing with the shell thickness towards the core of the particle whose surface is at 3 nm. For the same powder, the content (204) of Si (indicated by ▪) is gradually increasing to 100% at the core's surface. In contrast with the inventive particles, a different variation of x for the particles of the Comparative Experiments is observed. The particles of Comparative Experiment 2 do not contain SiO₂ at their outer-surface of their shell whereas for both Comparative Experiments it seems that the core of the particles contains O₂ as well.

### ELECTRODE PREPARATION

Composite electrode materials were made from 160 mg of the powders of the Examples and Comparative Experiments, 24 mg of carbon black (CB) and 16 mg of carboxymethyl cellulose (CMC). 200 mg of the composite electrode material was introduced in a silicon nitride vial. 0.75 mL of a pH3 buffer solution, prepared with 3.842 g citric acid and 0.402 g of KOH in 100 mL of deionized water, was added to the composite electrode materials. Three silicon nitride balls each of 9.5 mm diameter served as mixing media. The above composition was mixed until a slurry was obtained. A Fritsch pulverisette 7 mixer was used to mill the slurry at 500 rpm for 60 min. The slurry was tape-cast onto a 25 pm thick copper foil, dried for 12 hours at room temperature in air and then for 2 hours at 100° C. in vacuum. The thickness of the obtained electrode was between 10 and 40 pm, which corresponds to 0.7-1.5 mg/cm² of silicon per electrode.

FIG. 3 shows (300) the absorbance (in a.u.) versus the wavenumber (cm⁻¹) for CMC (301), the powders of C.Ex.1 (302); C.Ex.2 (303); Ex.1 (304) and Ex.5 (305) as well as for the mixtures CMC/C.Ex.1 (306); CMC/C.Ex.2 (307); CMC/Ex.1 (308) and CMC/Ex.5 (309). By infrared spectroscopy, a carboxylate group peak at 1580 cm⁻¹ can be observed in pure CMC. The peaks for the Si-CMC composite at 1640 cm⁻¹ can be assigned to the stretching band of carbonyl group indicating that CMC has been grafted onto the surface of Si particles.

### ELECTROCHEMICAL TESTING

Electrochemical cells (Swagelok-type) were used for the electrochemical tests and were assembled in an argon filled glove box. The cells were cycled using a VMP automatic cycling data recording system (Biologic Co.) operating in galvanostatic mode between 1 and 0.005 V versus Li⁺/Li^{o}.

The cells comprised a 0.78 cm² disc of the composite electrode obtained as described above which was used for testing as the positive electrode. A whatman GF/D borosilicate glass-fibre sheet was used as separator, saturated with a 1M LiPF6 electrolyte solution (1/1 diethyl carbonate/ethylene carbonate and 10 wt % of fluoro ethylene carbonate (FEC) and 2 wt % of vinylene carbonate (VC) (LiPF6+DEC+EC+FEC+VC=100 wt. %)). A 1 cm² Li metal disc was used as the negative (reference) electrode.

The cells were cycled with a limited discharge (alloying) capacity of 1 200 mAh/g of silicon at a rate of one lithium in two hours (C/2) both in discharge and charge (de-alloying). The first irreversible capacity after one cycle and the cycle life of the cells were measured.

The cycle life is the number of such cycles that can be performed until the mentioned capacity of 1200 mAh/g of silicon can no longer be reached.

The results are presented in the Table in the section ‘battery properties of battery produced with powder’.

It is observed that in particular the cycle life of the batteries made with the powders according to examples 1-9 is much higher than the cycle life of the batteries made with the powders according to comparative experiments 1 and 2.

Also the first irreversible loss of the batteries made with the powders according to examples 1-9 is in general lower than first irreversible loss of the batteries made with the powders according to comparative experiments 1 and 2.

The inventors speculate that the beneficial effect of the invention may be explained by hypothesis that the SiO2 outer shell layer, together with lithium silicates which are the electrochemical-reaction product of lithium with SiOₓ with x<2, forms a better protective layer that reduces the mechanical degradation of Si, and thereby increase the cycle life, while negative effects that SiOₓ with x<2 has on the first irreversible loss are tempered by the relatively moderate amounts of Silicon suboxide.

TABLE

| | C-Ex 1 | C-Ex 2 | Ex 1 | Ex 2 | Ex 3 | Ex 4 | Ex 5 | Ex 6 | Ex 7 | Ex 8 | Ex 9 |
|---|---|---|---|---|---|---|---|---|---|---|---|
| Powder manufacturing conditions | | | | | | | | | | | |
| Oxidation temperature (° C.) | — | — | 300 | 300 | 300 | 500 | 500 | 500 | 700 | 700 | 700 |
| Oxidation time (min) | — | — | 10 | 30 | 60 | 10 | 30 | 60 | 10 | 30 | 60 |
| Powder characterisation | | | | | | | | | | | |
| Shell composition | Mainly SiO₂ | SiOx | SiOx | SiOx | SiOx | SiOx | SiOx | SiOx | SiOx | SiOx | SiOx |
| Shell outer surface composition | SiO2 | SiOx | SiO2 | SiO2 | SiO2 | SiO2 | SiO2 | SiO2 | SiO2 | SiO2 | SiO2 |
| Shell thickness (nm) | 2 | 0.5 | 1 | nd | 1.5 | 1.5 | 1.5 | 1.5 | nd | 2 | 2 |
| Amount Si⁴⁺ | 95% | 68% | 70% | nd | 78% | 72% | 80% | 89% | nd | 82% | 83% |
| Amount Si³⁺ | <1% | 3% | nd | nd | 8% | nd | 6% | nd | nd | nd | 4% |
| Amount Si²⁺ | <2% | 4% | nd | nd | 8% | nd | 6% | nd | nd | nd | 5% |
| Amount Si¹⁺ | 3% | 25% | 15% | nd | 10% | 12% | 8% | 5% | nd | 8% | 8% |
| ${\sum }_{m = 1}^{3} amount {Si}^{m +}$ | 5% | 32% | 30% | nd | 22% | 28% | 20% | 11% | nd | 18% | 17% |
| SiOH_{free} content of powder (−/nm²) | 1.2 | 0.8 | 0.9 | 1.0 | 1.0 | 1.1 | 1.1 | 1.1 | 1.2 | 1.2 | 1.3 |
| BET (m²/g) of powder | 54 | 25 | 26 | nd | 22 | 19 | 20 | 29 | nd | 27 | 29 |
| Oxygen content of powder (wt. %) | 6 | 4 | 2 | nd | nd | 4.2 | 4.2 | nd | nd | nd | nd |
| Isoelectric point of powder | 3 | No | <2.2 | nd | nd | nd | <2.2 | <2.2 | nd | nd | <2.2 |
| Battery properties of battery produced with powder | | | | | | | | | | | |
| 1st irreversible loss (mAh/g) | 450 | 550 | 530 | 390 | 390 | 400 | 360 | 390 | 440 | 450 | 560 |
| Cycle life (—) | 430 | 80 | 530 | 530 | 570 | 580 | 600 | 610 | 530 | 560 | 540 |

nd = not determined

1-22. (canceled)

23. A powder comprising particles containing a core and a shell, said core containing silicon (Si) and said shell containing silicon oxide SiOₓ with 0<x<2, characterized in that said silicon oxide contains Siⁿ⁺ cations with n being an integer from 1 to 4, wherein said silicon oxide contains Si⁴⁺ cations in an amount of at least 70 mol % of the total amount of Siⁿ⁺ cations.

24. A powder according to claim 23, wherein said silicon oxide contains Si⁴⁺ cations in an amount of at most 90 mol % of the total amount of Siⁿ⁺cations.

25. A powder according to claim 23, said shell having a shell outer-surface and a shell volume, wherein the shell volume comprises SiOₓ with 0<x<2 and the shell outer-surface comprises SiO₂.

26. A powder according to claim 25, wherein the shell volume consists of SiOₓ with 0<x<2 and the shell outer-surface consists of SiO₂.

27. A powder according to claim 25, wherein the core has a core-surface and wherein x is continuously decreasing with respect to the thickness of the shell, from 2 at the shell outer-surface to 0 at the core-surface.

28. A powder according to claim 27, wherein x has a continuous rate of change with respect to the thickness of the shell.

29. A powder according to claim 23, wherein said shell has a shell thickness of between 1 and 5 nm.

30. A powder according to claim 23, wherein said shell has a shell outer-surface comprising free SiOH groups.

31. A powder according to claim 23, having a total oxygen content of more than 3 wt % at room temperature.

32. A powder according to claim 23, wherein the oxygen content is between 3 and 10 wt %.

33. A powder according to claim 23, having an average particle size of between 0.01 μm and 1 μm.

34. A powder according to claim 23, said powder having a BET surface area of at most 50 m²/g.

35. A powder according to claim 34, said powder having a BET surface area of at most 30 m²/g.

36. A powder according to claim 34, said powder having a BET surface area of at most 20 m²/g.

37. A powder according to claim 23, wherein the core is formed of zerovalent silicon.

38. A powder according to claim 37, wherein the core consists of crystalline silicon.

39. A method for preparing a powder, comprising the steps of:
a. providing a powder comprising particles, said particles comprising a core containing silicon and an initial shell having a shell outer-surface and a shell volume, wherein the shell volume comprises SiOₓ with 0<x<2 and wherein said initial shell has a shell thickness of between 0.5 nm and 3 nm, wherein the powder has a BET surface area of between 10 and 40 m²/g;
b. subjecting the powder to an etching step with an HF water-based solution to partially remove and/or reduce the thickness of the SiOₓ shell and produce SiOH groups on the outer-surface of the shell; and
c. subjecting the etched powder to an oxidizing heat treatment at an oxidizing temperature of between 250° C. and 750° C. for between 5 min and 80 min.

40. A negative electrode material comprising a powder according to claim 23.

41. The negative electrode material according to claim 40, further comprising a polymeric binder, wherein the shell of the powder has a shell outer-surface comprising free SiOH groups and wherein at least part of said binder is covalently bonded to the powder via the SiOH groups.

42. A negative electrode material according to claim 41, wherein said binder is carboxymethyl cellulose (CMC).

43. A negative electrode of a battery, comprising the negative electrode material of claim 41, and an electrically conductive agent, whereby the electrode contains between 70 wt % and 90 wt % of the powder, between 5 wt % and 15 wt % of the electrically conductive agent and between 5 wt % and 15 wt % of the binder.

44. A rechargeable battery comprising a positive electrode, an electrolyte and a negative electrode according to claim 43.
